(19) United States
(12) Patent Application Publication
(10) Pub. No.: US 2006/0109407 A1
(43) Pub. Date: May 25, 2006

(54) Liquid crystal display and method for fabricating the same

(76) Inventor: Sang-Uk Kim, Suwon-si (KR)

Correspondence Address: CHRISTIE, PARKER & HALE, LLP, PO BOX 7068, PASADENA, CA, 91109-7068, US

(21) Appl. No.: 11/282,427

(22) Filed: Nov. 18, 2005

(30) Foreign Application Priority Data
Nov. 24, 2004 (KR) 2004-97180

(51) Int. Cl. G02F 1/141

(52) U.S. Cl. 349/134

(57) ABSTRACT

A liquid crystal display and a method for fabricating the liquid crystal display. The liquid crystal display includes a substrate having a plurality of pixel regions, each pixel region having a thin film transistor formed therein; an insulation layer formed on the substrate; a pixel electrode formed on the insulation layer and connected to a drain electrode of the thin film transistor such that the pixel electrode covers at least a portion of an upper part of a gate electrode of the thin film transistor; and a liquid crystal layer disposed over the pixel electrode.

### CROSS-REFERENCE TO RELATED APPLICATION

This application claims priority to and the benefit of Korean Patent Application No. 10-2004-0097180, filed on Nov. 24, 2004, the entire content of which is incorporated herein by reference.

### BACKGROUND OF THE INVENTION

1. Field of the Invention

The present invention relates to a liquid crystal display and a method for fabricating the same, and more particularly, to a liquid crystal display with a structure for easily forming a transition core of a liquid crystal layer by forming pixel electrodes having a certain tilt angle, and a method for fabricating the same.

2. Description of Related Art

A liquid crystal display is generally formed by laminating a first (or opposite) substrate, on which an opposite electrode (e.g., a common electrode), a color filter, etc. are formed, onto a second substrate, on which an array having a thin film transistor, wirings and pixel electrodes is formed, and then injecting liquid crystals into a space between the second substrate and the first (or opposite) substrate.

In a liquid crystal display, an electric field is applied between the pixel electrodes and the opposite electrode, and liquid crystals are aligned by the electric field so that a light transmittance of the liquid crystals is controlled to display a gray scale. Because of this, viewing angles and display characteristics of the liquid crystal display depend on alignment of the liquid crystals.

Recently, an optically compensated bend (OCB) mode liquid crystal display of the liquid crystal displays has been actively studied due to its abilities for providing a wide viewing angle and a fast response speed. An OCB mode is a mode for aligning and driving a liquid crystal layer of a liquid crystal display in which a gray scale is displayed according to an orientation of liquid crystals in a bend state as an electric field is being applied from the outside after the liquid crystals first changed from a splay state to the bend state.

Therefore, for the OCB mode liquid crystal display to properly represent images, it is important to uniformly change the alignment of all liquid crystals (or liquid crystal molecules) over a display surface of the OCB mode liquid crystal display from the splay state to the bend state. As such, a method for applying a high transition voltage has been developed to change the alignment of most of the liquid crystals over the display surface. However, this method for increasing the transition voltage has a problem in that a power consumption is increased.

To reduce the power consumption, a method for forming a transition core of liquid crystals and changing an alignment of the liquid crystals around the transition core has been developed to change the alignment of most of the liquid crystals. As such, the formation of the transition core can reduce a transition voltage by increasing a pre-tilt angle of certain liquid crystals using an alignment film (or a structure of the film) for forming the transition core, thereby enabling the liquid crystals around the transition core to be changed and/or aligned more easily.

However, the increase of the pre-tilt angle described above has a problem in that a process for manufacturing the liquid crystal display is further complicated by the formation of the alignment film or the structure of a lower part of the alignment film.

### SUMMARY OF THE INVENTION

One exemplary embodiment of the present invention easily forms a transition core of liquid crystals (or liquid crystalline molecules) by tilting one or more parts of one or more pixel electrodes using a structure formed on a substrate.

Another exemplary embodiment of the present invention easily forms a transition core of the liquid crystalline molecules by forming a region whose gap is decreased in unit pixels by using a structure formed on a substrate.

Another exemplary embodiment of the present invention reduces a power consumption of a display device and improves a response speed and a gray scale display capability of the display device by easily forming a transition core, to thereby reduce a transition voltage.

An exemplary embodiment of the present invention provides a liquid crystal display including a substrate having a plurality of pixel regions, each pixel region having a thin film transistor formed therein; an insulation layer formed on the substrate; a pixel electrode formed on the insulation layer and connected to a drain electrode of the thin film transistor such that the pixel electrode covers at least a portion of an upper part of a gate electrode of the thin film transistor; and a liquid crystal layer disposed over the pixel electrode.

The liquid crystal layer may be an optically compensated bend (OCB) mode liquid crystal layer.

The insulation layer may include an inorganic insulation layer.

Another exemplary embodiment of the present invention provides a method for fabricating a liquid crystal display. A thin film transistor is formed in each of pixel regions on a substrate. An insulation layer is formed on the substrate and the thin film transistor. A via hole is formed in the insulation layer to expose at least a portion of a drain electrode of the thin film transistor. A pixel electrode is formed such that the pixel electrode is connected to the drain electrode of the thin film transistor through the via hole, and covers at least a portion of an upper part of a gate electrode of the thin film transistor by patterning a conductive film after placing the conductive film on the insulation layer. Another substrate is assembled with the substrate, and a liquid crystal layer is injected between the substrate and the another substrate.

### BRIEF DESCRIPTION OF THE DRAWINGS

The accompanying drawings, together with the specification, illustrate exemplary embodiments of the present invention, and, together with the description, serve to explain the principles of the invention.

FIG. 1A is a plan view of a substrate on which an array is formed, according to a first exemplary embodiment of the present invention;

FIG. 1B is a cross-sectional view taken along the line I-I′ of FIG. 1A.

FIG. 2 is a cross-sectional view illustrating a sealed substrate;

FIG. 3 is a cross-sectional view of unit pixels according to the first exemplary embodiment of the present invention;

FIG. 4 is a plan view of a substrate on which an array is formed, according to a second exemplary embodiment of the present invention; and

FIG. 5 is a cross-sectional view of a unit pixel, according to the second exemplary embodiment of the present invention, taken along the line II-II′ of FIG. 4.

### EXPLANATION OF REFERENCE NUMERALS FOR CERTAIN PARTS OF THE DRAWINGS

| | |
|---|---|
| 100: substrate | 110: gate electrode |
| 115: gate insulation layer | 120: semiconductor layer |
| 130a: source electrode | 130b: drain electrode |
| 135: insulation layer | 140, 140a: pixel electrode |
| 137: via hole | 145a: alignment film |
| 145, 225: alignment film | 205: black matrix |
| 210: color filter | 215: common electrode |

### DETAILED DESCRIPTION

In the following detailed description, exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, rather than restrictive. There may be parts shown in the drawings, or parts not shown in the drawings, that are not discussed in the specification, as they are not essential to a complete understanding of the invention. Like reference numerals designate like elements. In the drawings, length of layers and regions, thickness, etc. can be exaggerated for convenience of understanding.

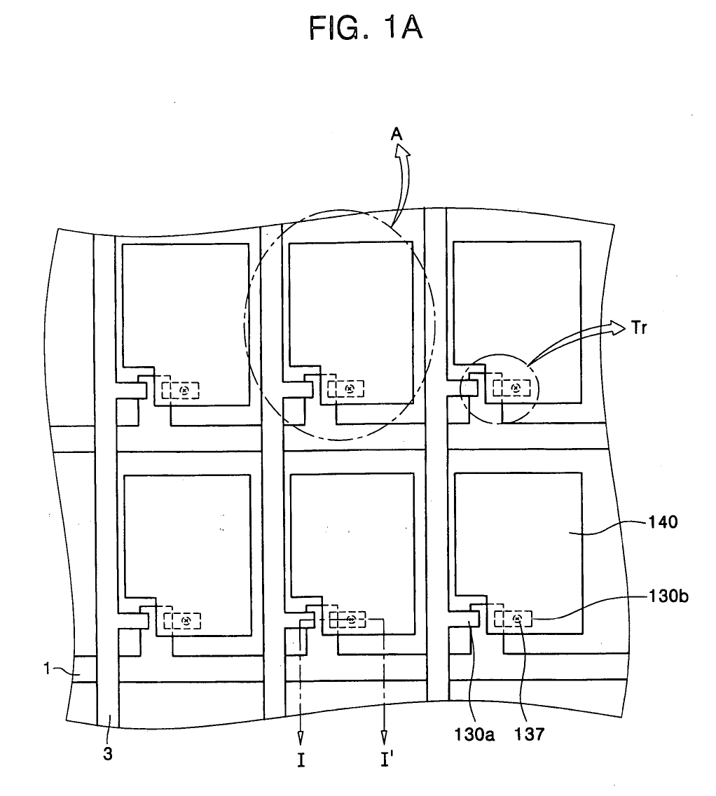

FIG. 1A is a plan view of a substrate on which an array is formed, according to a first exemplary embodiment of the present invention.

Referring to FIG. 1A, a thin film transistor Tr is formed in each of the unit pixel regions on a substrate on which unit pixel regions A are formed. The respective thin film transistors Tr are connected to gate lines 1 that are scanning signal lines and source lines 3 that are image signal lines, so that the thin film transistors are operated according to signals inputted from the wirings. Pixel electrodes 140 connected to the thin film transistors Tr are formed in the unit pixel regions A. The pixel electrodes 140 are connected to drain electrodes 130b of the thin film transistors Tr and formed in such a way that each of the pixel electrodes 140 covers a portion of an upper part of a gate electrode 110 (see FIG. 1B) of a corresponding one of the thin film transistors Tr.

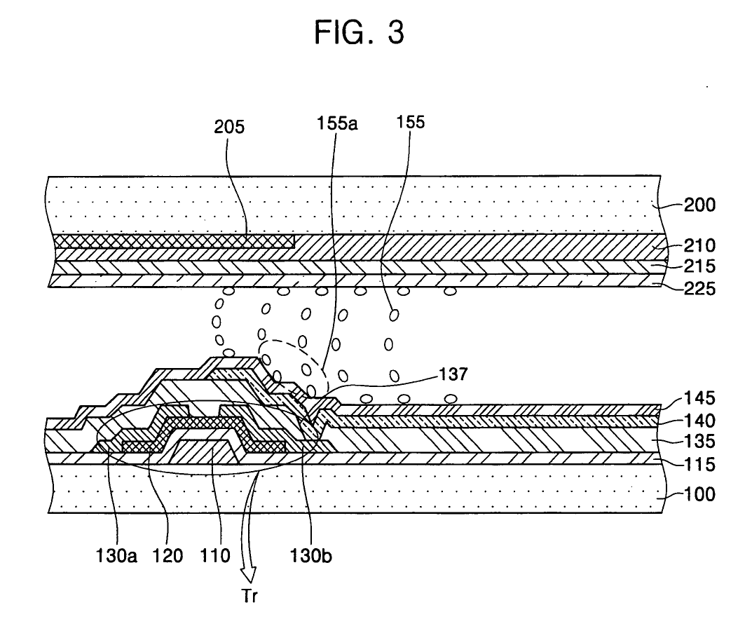

FIG. 3 is a cross-sectional view taken along the line I-I′ of FIG. 1A, in which an opposite substrate is formed on a substrate of FIG. 1A. Hence, FIG. 3 is a cross-sectional view of a unit pixel according to the first exemplary embodiment of the present invention.

Referring to FIG. 3, a structure of one of the unit pixels is described in detail as follows. A gate electrode 110 is formed on a substrate 100. A gate insulation layer 115 is formed on the gate electrode 110, and a semiconductor layer 120 corresponding to the gate electrode 110 is formed on the gate insulation layer 115. A source electrode 130a and a drain electrode 130b are formed such that they are contacted with a portion of the semiconductor layer 120.

An insulation layer 135 is formed on a thin film transistor Tr including the semiconductor layer 120, the gate electrode 110, the source electrode 130a and the drain electrode 130b. The insulation layer 135 can be an inorganic passivation layer. Therefore, the insulation layer is formed in such a way that a planarization operation is decreased so that prominence and depression on a substrate can be used to form a transition core of a liquid crystal layer, which can be described as follows.

A pixel electrode 140 that is connected to the drain electrode 130b of the thin film transistor Tr through a via hole 137 and covers a portion of an upper part of the gate electrode 110 of the thin film transistor Tr is formed on the insulation layer 135.

An opposite substrate 200 on which a common electrode 215 is formed, is disposed opposite to the substrate on which the thin film transistor Tr and the pixel electrode 140 are formed. A black matrix 205 is formed on the opposite substrate 200. The black matrix 205 is formed on regions except for light emitting regions of the liquid crystal display to play a role of increasing a contrast ratio of the liquid crystal display.

A color filter 210 is formed on the black matrix 205 which is formed on the opposite substrate 200. A common electrode 215 is formed on the color filter 210.

A liquid crystal layer 155 is interposed between the common electrode 215 and the pixel electrode 140.

The liquid crystal layer may be an OCB mode liquid crystal layer. Further, alignment films 225, 145 may be respectively interposed between the liquid crystal layer 155 and the common electrode 215 and between the liquid crystal layer 155 and the pixel electrode 140, and the alignment films 145, 225 may have a certain pre-tilt angle. That is, by performing a rubbing process, the alignment films 145, 225 may have a certain pre-tilt angle, and the pre-tilt angle may be 6 to 10 degrees.

A surface level difference between a portion of the pixel electrode formed on an upper part of the gate electrode and another portion of the pixel electrode formed on the lowest part of the pixel region may be 0.2 to 0.5 μM. The surface level difference is controlled to control a tilt formed on the periphery of the drain electrode of the thin film transistor and a cell gap of a region in which a transition core is to be formed.

Therefore, a portion of the pixel electrode 140 formed on the periphery of a boundary surface of the thin film transistor Tr may have a certain tilt. Further, a liquid crystal 155a disposed at the periphery of the boundary surface of the thin film transistor Tr may have a tilt angle obtained by adding a pre-tilt angle of the liquid crystal layer 155 and a tilt angle of the portion of the pixel electrode.

The tilt angle increases an orientation angle of liquid crystals existing on a portion corresponding to the tilt angle, thereby resulting in an easy transition of the liquid crystals compared with liquid crystals existing on a portion without the tilt angle, so that the tilt angle acts as a transition core functioning as a catalyst during the transition of the other liquid crystals.

Therefore, a transition core of liquid crystal molecules is easily formed by forming a tilt on a portion of the pixel electrode by using a tilt structure formed by the thin film transistor formed on the substrate.

Further, a gap between the substrate 100 and the opposite substrate 200 (i.e., a gap between structures formed on the substrates 100 and 200) is smaller in a region in which the structure formed on the substrate 100 has the most height than in other regions. That is, a cell gap is the smallest in an upper part of the thin film transistor Tr on which the pixel electrode 140 is partially formed. Therefore, liquid crystal molecules in an upper region of the thin film transistor Tr receive a relatively stronger electric field to result in an easy formation of the transition core.

Therefore, the transition core of the liquid crystal molecules is easily formed to reduce a transition voltage and reduce a power consumption of the liquid crystal display accordingly. Further, the formation of the transition core increases a transition speed to improve response speed and gray scale display capability of the liquid crystal display.

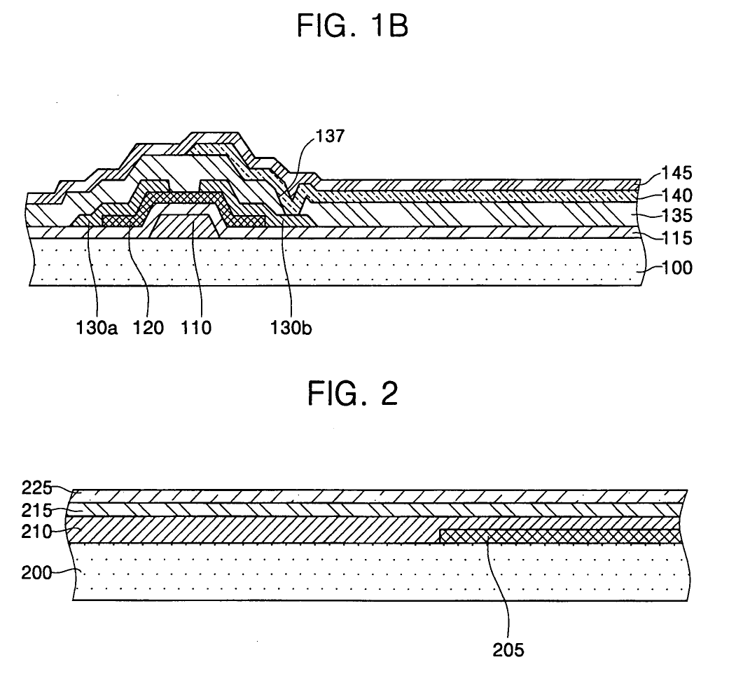

FIG. 1B is a cross-sectional view taken along the line I-I′ of FIG. 1A, and FIG. 2 is a cross-sectional view illustrating a sealed substrate. Referring to FIG. 1B, FIG. 2 and FIG. 3, a method for fabricating the liquid crystal display according to the first exemplary embodiment of the present invention is described in detail as follows.

A thin film transistor Tr is formed per each of unit pixel regions (the regions A of FIG. 1) formed on a substrate 100.

That is, a gate electrode 110 is formed by patterning a conductive film after depositing the conductive film on the substrate 100. A gate insulation layer 115 is formed on the gate electrode 110. The gate insulation layer 115 may be a silicon oxide film and can be patterned.

A semiconductor layer 120 is formed by patterning an amorphous silicon film after depositing the amorphous silicon film on the gate insulation layer 115 or patterning a polycrystalline silicon film after crystallizing the amorphous silicon film into the polycrystalline silicon film. The thin film transistor Tr is formed by patterning a conductive film, thereby forming a source electrode 130a and a drain electrode 130b after depositing the conductive film on the semiconductor layer 120.

An insulation layer 135 is formed on a substrate 100 on which the thin film transistor Tr is formed, and a via hole 137 for exposing the drain electrode 130b is formed in the insulation layer 135. The insulation layer 135 may be an inorganic passivation layer or a silicon nitride film.

A pixel electrode 140 is formed in such a manner that the pixel electrode is connected through the via hole 137 to the drain electrode 130b of the thin film transistor Tr and partially covers an upper part of the gate electrode 110 of the thin film transistor Tr by patterning a conductive film after depositing the conductive film on the insulation layer 135. An alignment film 145 is formed on the substrate after the pixel electrode 140 is formed.

The pixel electrode 140 is formed in such a manner that a certain tilt angle is formed on a periphery of a boundary surface of the thin film transistor Tr. That is, since the pixel electrode 140 is overlapped with a portion of an upper part of the thin film transistor Tr, the pixel electrode 140 has a certain tilt angle due to a tilt structure formed on a lower part of the pixel electrode. Therefore, a certain tilt is formed on the periphery of the drain electrode of the thin film transistor Tr.

A surface level difference between a portion of the pixel electrode 140 formed on an upper part of the gate electrode and another portion of the pixel electrode 140 formed on the lowest part of the pixel region may be 0.2 to 0.5 μm. The surface level difference is controlled to control a tilt formed on the periphery of the drain electrode of the thin film transistor and a cell gap of a region in which a transition core is to be formed.

Referring to FIG. 2, a black matrix 205 for defining pixels is first deposited on a substrate 200 to form an opposite substrate facing the substrate 100. A color filter 210 is formed on the black matrix 205 which is formed on the substrate 200. A common electrode 215, which is an opposite electrode, is formed on the color filter 210. The common electrode may be formed using indium tin oxide (ITO). An alignment film 225 is formed on the common electrode 215.

Referring to FIG. 3, a liquid crystal layer 155 is injected into a space between the substrate 100 and the opposite substrate 200 after sealing the substrate 100 and the opposite substrate 200 such that the alignment film 145 on the substrate 100 of FIG. 1B and the alignment film 225 on the opposite substrate 200 of FIG. 2 face each other.

The liquid crystal layer 155 may be an OCB mode liquid crystal layer. Further, the liquid crystal layer 155 is aligned such that the liquid crystal layer has a certain pre-tilt angle. That is, the liquid crystal layer is adjusted to obtain a certain pre-tilt angle by adjusting strength and direction of rubbing when forming the alignment film. The pre-tilt angle may be 6 to 10 degrees.

Further, a liquid crystal layer 155a disposed at a periphery of the boundary surface of the thin film transistor Tr may have a tilt angle obtained by adding a pre-tilt angle of the liquid crystal layer and a tilt angle of the pixel electrode 140 described in reference to FIG. 1B.

Therefore, a transition core of the liquid crystal molecules is easily formed by forming a tilt on a portion of the pixel electrode using a tilt structure formed by the thin film transistor formed on the substrate. Further, the thin film transistor Tr is formed such that a cell gap in an upper part of the thin film transistor Tr on which the pixel electrode 140 is partially formed is the smallest. Accordingly, the liquid crystal molecules in an upper region of the thin film transistor Tr have a relatively stronger electric field to result in an easy formation of the transition core.

Therefore, the transition core of the liquid crystal molecules is easily formed to reduce a transition voltage and reduce a power consumption of the liquid crystal display accordingly. Further, the formation of the transition core increases a transition speed to improve response speed and gray scale display capability of the liquid crystal display.

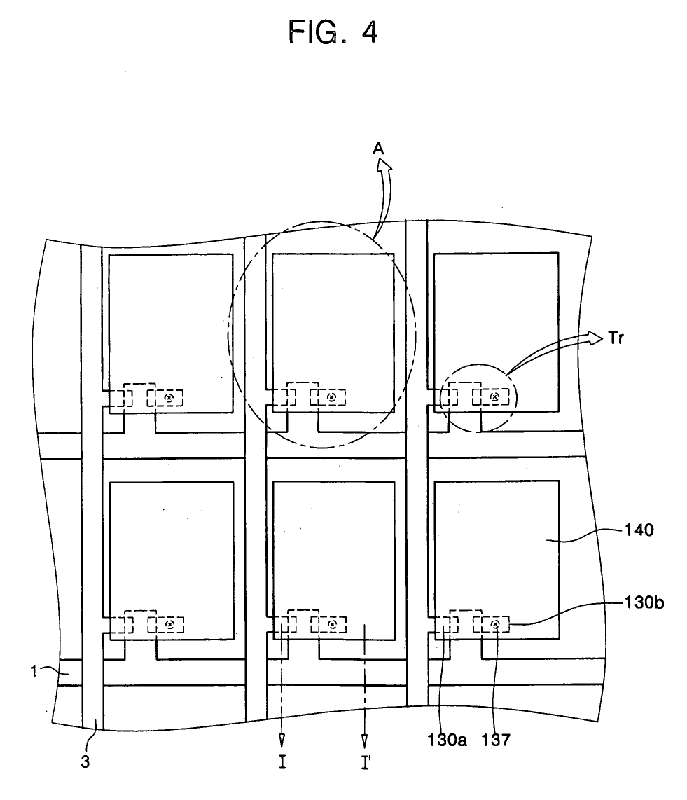

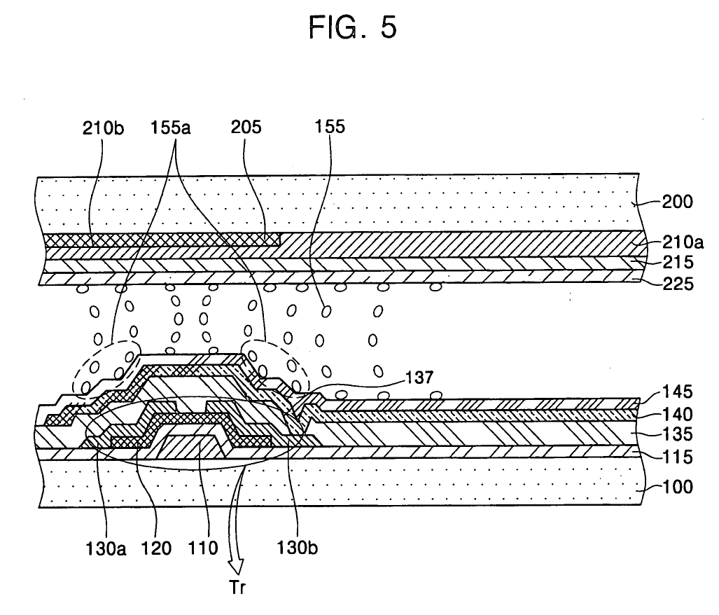

FIG. 4 is a plan view of a substrate on which an array is formed, according to a second exemplary embodiment of the present invention, and FIG. 5 is a cross-sectional view for a unit pixel, taken along the line II-II′ of FIG. 4, according to the second exemplary embodiment of the present invention.

Referring to FIG. 4 and FIG. 5, a liquid crystal display according to the second exemplary embodiment of the present invention has a structure in which a pixel electrode 140a covers the entire upper part of a thin film transistor Tr, which is different from a liquid crystal display according to the first exemplary embodiment of the present invention. Therefore, a portion of the pixel electrode formed on the periphery of the boundary surface of the thin film transistor may have a certain tilt angle.

Further, a liquid crystal layer disposed on a periphery of the boundary surface of the thin film transistor may have a tilt angle obtained by adding a pre-tilt angle of the liquid crystal layer and a tilt angle of the pixel electrode.

Therefore, forming a tilt structure along the periphery of the thin film transistor further increases the tilt angle, and a transition core of the liquid crystal molecules is easily formed by using a tilt structure formed due to the thin film transistor formed on the substrate.

The transition core of the liquid crystal molecules is easily formed to reduce a transition voltage and to reduce a power consumption of the liquid crystal display accordingly. Further, the formation of the transition core increases a transition speed to improve response speed and gray scale display capability of the liquid crystal display.

Referring to FIG. 4 and FIG. 5, a method for fabricating a liquid crystal display according to the second exemplary embodiment of the present invention is described as follows.

In the same manner as in the method according to the first exemplary embodiment of the present invention, a thin film transistor Tr is formed in each of the unit pixel regions A′ on a substrate 100 having the unit pixel regions A′. Further, an insulation layer 135 is formed on the substrate 100. A via hole 137 for exposing a drain electrode 130b is formed in the insulation layer 135.

By patterning a conductive film, a pixel electrode 140a is formed on the insulation layer 135. The pixel electrode 140a is connected to the drain electrode 130b of the thin film transistor Tr, and covers the entire upper part of the thin film transistor Tr. Therefore, the pixel electrode 140a envelopes the top or the upper part the thin film transistor Tr, and a certain tilt angle is formed on a periphery of a boundary surface of the thin film transistor.

An opposite substrate 200 is assembled with the substrate 100 in the same manner as in the first exemplary embodiment, and a liquid crystal layer 155 is injected between the substrate 100 and the opposite substrate 200.

The method further includes respectively forming alignment films on the substrates, thereby aligning the liquid crystal layer 155 such that the liquid crystal layer has a certain pre-tilt angle before assembling the opposite substrate 200 with the substrate 100, and injecting the liquid crystal layer 155 between the substrate 100 and the opposite substrate 200. The liquid crystal layer 155 formed on the periphery of the boundary surface of the thin film transistor Tr may have a tilt angle obtained by adding a pre-tilt angle of the liquid crystal layer and a tilt angle of the pixel electrode. Therefore, the tilt angle is further increased by forming a tilt structure along the periphery of the thin film transistor Tr.

A liquid crystal display and a method for fabricating the same according to the present invention have an effect of easily forming a transition core of liquid crystal molecules by forming a tilt on one or more portions of pixel electrodes using a tilt structure formed by a thin film transistor formed on a substrate.

Further, a liquid crystal display and a method for fabricating the same according to exemplary embodiments of the present invention have an effect that the transition core is easily formed in a region by forming the region in which a cell gap is relatively small using a structure formed on the substrate.

Therefore, a liquid crystal display and a method for fabricating the same according to the exemplary embodiments of the present invention result in a reduced transition voltage by easily forming the transition core so that a power consumption of the liquid crystal display is reduced accordingly and have effects that a response speed and a gray scale display capability of the liquid crystal display are improved by increasing the transition speed due to the formation of the transition core.

While the invention has been shown and/or described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. A liquid crystal display comprising:
a substrate having a plurality of pixel regions, each pixel region having a thin film transistor formed therein;
an insulation layer formed on the substrate;
a pixel electrode formed on the insulation layer and connected to a drain electrode of the thin film transistor such that the pixel electrode covers at least a portion of an upper part of a gate electrode of the thin film transistor; and
a liquid crystal layer disposed over the pixel electrode.

2. The liquid crystal display according to claim 1, wherein the liquid crystal layer comprises an optically compensated bend (OCB) mode liquid crystal layer.

3. The liquid crystal display according to claim 2, wherein the liquid crystal display further comprises an alignment film interposed between the liquid crystal layer and the pixel electrode, wherein the alignment film has a certain pre-tilt angle.

4. The liquid crystal display according to claim 3, wherein the pre-tilt angle of the alignment film is 6 to 10 degrees.

5. The liquid crystal display according to claim 1, wherein the pixel electrode is formed such that the pixel electrode entirely covers the upper part of the thin film transistor.

6. The liquid crystal display according to claim 1, wherein the insulation layer comprises an inorganic insulation layer.

7. The liquid crystal display according to claim 1, wherein a surface level difference between a portion of the pixel electrode formed on the upper part of the gate electrode and another portion of the pixel electrode formed on a lowest part of a corresponding one of the pixel regions is 0.2 to 0.5 μm.

8. A method for fabricating a liquid crystal display comprising:
forming a thin film transistor in each of pixel regions on a substrate
forming an insulation layer on the substrate and the thin film transistor;
forming a via hole in the insulation layer to expose at least a portion of a drain electrode of the thin film transistor;
forming a pixel electrode such that the pixel electrode is connected to the drain electrode of the thin film transistor through the via hole, and covers at least a portion of an upper part of a gate electrode of the thin film transistor by patterning a conductive film after placing the conductive film on the insulation layer;
assembling another substrate with the substrate; and
injecting a liquid crystal layer between the substrate and the another substrate.

9. The method for fabricating the liquid crystal display according to claim 8, wherein the liquid crystal layer comprises an optically compensated bend (OCB) mode liquid crystal layer.

10. The method for fabricating the liquid crystal display according to claim 9, wherein the method further comprises, before assembling the another substrate with the substrate, forming an alignment film on the pixel electrode such that the alignment film has a certain pre-tilt angle.

11. The method for fabricating the liquid crystal display according to claim 10, wherein the pre-tilt angle of the alignment film is 6 to 10 degrees.

12. The method for fabricating the liquid crystal display according to claim 8, wherein the pixel electrode is formed such that the pixel electrode entirely covers the upper part of the thin film transistor.

13. The method for fabricating the liquid crystal display according to claim 8, wherein the insulation layer comprises an inorganic insulation layer.

14. The method for fabricating the liquid crystal display according to claim 8, wherein a surface level difference between a portion of the pixel electrode formed on the upper part of the gate electrode and another portion of the pixel electrode formed on a lowest part of a corresponding one of the pixel regions is 0.2 to 0.5 μm.
